(19) United States
(12) Patent Application Publication
(10) Pub. No.: US 2013/0082159 A1
(43) Pub. Date: Apr. 4, 2013

(54) REINFORCED LEG DEVICE FOR CHARCOAL BROILER

(71) Applicant: Kyung Hwan Kim, Gyeonggi-do (KR)

(72) Inventor: Kyung Hwan Kim, Gyeonggi-do (KR)

(73) Assignees: Young Do WON, Gyeonggi-do (KR); Kyung Hwan KIM, Gyeonggi-do (KR)

(21) Appl. No.: 13/504,086

(22) PCT Filed: Oct. 26, 2010
(86) PCT No.: PCT/KR2010/007389

§ 371 Date: Jul. 9, 2012

(30) Foreign Application Priority Data
Oct. 26, 2009 (KR) 10-2009-0101938

(51) Int. Cl. A47J 37/07

(52) U.S. Cl. CPC A47J 37/0786
USPC 248/688

(57) ABSTRACT

The present invention provides a reinforced leg device for a charcoal broiler, and the reinforced leg device comprises: reinforced steel wires which are provided at the front and rear edges on the bottom surface inside a housing of a portable charcoal broiler; insertion holes which are formed in sets on the left and right sides of front and rear sidewalls which form the width of the housing positioned on the upper side of the reinforced steel wires; and leg units which are stored by being inserted into the insertion holes of each set, and function as support legs after being unfolded. The leg units comprise: insertion bars which are inserted into the inside of the housing through the insertion holes of each set; first bending bars which are vertically inclined toward the inner side of a vertical surface of the insertion holes from the outer side of the housing of the insertion bars when the leg units are folded; support bars which are bent in the width direction of the charcoal broiler on the lower end of the first bending bars, and function as supports of the housing when being placed and unfolded on the external bottom of the housing; and width connectors which are bent in the width direction on the end of the support bars, and function as legs by allowing lower ends to be connected together.

### TECHNICAL FIELD

The invention relates to charcoal grills. More particularly, this invention relates to a reinforced leg device for a charcoal grill configured in such a way that: reinforced steel wires are provided at the front and rear edges on the bottom surface inside a housing of the portable charcoal grill, thereby increasing the strength of the housing; two pairs of insertion holes are formed on the front and rear sidewalls of the housing, above the reinforced steel wires, respectively; and a pair of leg units each includes insertion bars inserted the insertion holes, serving as pivots thereon, respectively, and first bent bars, connected to the insertion bars, for supporting the external bottom surface of the housing. Since the leg units are supported via the reinforced steel wires arranged on the bottom of the housing, they don't distort the housing when they are folded or unfolded.

### BACKGROUND ART

Cookers are developed to employ a variety of heat sources, such as wood, charcoal, natural gas, petroleum, coal, electricity, etc.

Cookers using natural gas, petroleum, coal, electricity, etc. are advantageous in that they are convenient to use. On the contrary, they are disadvantageous in that, when they are used outdoors, the users must prepare electrical accessories, fuel such as petroleum, natural gas, etc. Since cookers have potential dangers while being used, the user must handle them carefully. In general, people prefer food cooked by cookers using charcoal than rather than by cookers using natural gas or electricity since food cooked by charcoal is more delicious.

Conventional charcoal grills are divided into portable types and disposable types, according to the use of charcoal. Portable charcoal grills are used in such a way that charcoal is put into in the housing each time that food is cooked. Disposable charcoal grills are configured in such a way that pieces of charcoal are installed in the aluminum container when they are manufactured.

FIGS. 1 and 2 show disposable charcoal grills. It is configured to include: a housing 2 where the side walls are widened in the upper direction; an internal support mesh 10 having a side wall support mesh 13 supported by the side walls, and a lower support mesh 11 for supporting charcoal 4; a charcoal fixing mesh 5 for covering and placing the charcoal 4 on the lower support mesh 11; and a wire roasting mesh 3 that is placed on the upper end of the side wall support mesh 13 and forms a chamber thereunder between itself and the charcoal fixing mesh 5. The housing 2 has a side wall 1 the end of which forms a bent band 9 that is bent to support the edge of the wire roasting mesh 3. Ignition material 12 for igniting the charcoal 4 is placed between the lower support mesh 11 and the internal bottom surface of the housing 2. The charcoal support mesh 5 and the internal support mesh 10 are securely coupled to each other by a coupling member. Reference number 6 refers to an air inlet. Reference number 7 is a door for opening the air inlet 6 to enter air into the housing 2.

FIG. 3 is a cross-sectional view depicting an exemplary example of a conventional charcoal grill. It is configured in such a way that: an ignition material support mesh 70 and an internal support mesh 20, placed on the bottom of the housing, supports charcoal; a charcoal fixing mesh 30 that covers charcoal 4 and is formed in such a way that interval maintaining downward-protruding parts 35 are bent down to separate and maintain an interval between the pieces of charcoal 4; and a wire roasting mesh 3 is placed on the charcoal fixing mesh 30 and serves to reduce the height of the housing.

The housing 2 forms bent grooves 80 for supporting a vertical weight on the side walls 1 at a certain distance. The internal support mesh 20 includes: a side support part 23, vertically bent to support the side of the charcoal 4; and a space maintaining part 22 for supporting the sidewall 1 of the housing 2 from the side support part 23 and the other side support parts. The portable charcoal grill includes space forming legs 24 for forming a space between the side support part 23 and the portion holding up the charcoal 4 of the internal support mesh 20, where an ignition material 12 is fitted into the space. The internal support mesh 20 forms a pushing portion 25 that protrudes downwards at the center thereof. The pushing portion 25 maintains the ignition material 12 in the center of the internal support mesh 20 between the space forming legs 24. Reference number 4-1 refers to a vertical hole for supplying air to the pieces of charcoal 4.

FIG. 4 is a cross-sectional view depicting another exemplary example of a conventional charcoal grill. It is configured in such a way that an internal support mesh is placed on the bottom of the housing and supports the pieces of charcoal. The configuration includes the same elements as the example of FIG. 3, and further includes a charcoal fixing mesh 30 that supports the pieces of charcoal 4. The charcoal fixing mesh 30 is formed in such a way that interval maintaining upward-protruding parts 36 are bent upwards to separate and maintain an interval between the pieces of charcoal 4.

FIG. 5 is a perspective view depicting a conventional support leg device that supports a charcoal grill. It is shaped as a rectangle, including: two first longwise support members 110; two second widthwise support members 120; and bent legs 110b and 120b formed by bending the end portions of the first and second support members 110 and 120 with respect to their bent portions 110a and 120a at a certain angle.

The conventional support leg device is manufactured in such a way that the bent legs 110b and 120b of the first 110 and second 120 support members are arranged facing each other and then the contact portions 130 are welded, thereby manufacturing the integral body.

However, the conventional support leg device is manufactured as a fixed structure, which creates an additional package, separated from the package of the portable charcoal grill, and thus increases the delivery cost.

### DISCLOSURE

### Technical Problem

The invention solves the above problems, and provides a reinforced leg device configured in such a way that: two pairs of insertion holes are formed on the front and rear sidewalls of the housing of a portable charcoal grill, respectively; and insertion bars integrally formed to both ends of a leg unit are pivotally inserted into each pair of insertion holes and rotates with respect to the sidewalls of the housing.

The invention further provides a reinforced leg device configured in such a way that: insertion bars of both ends of a leg unit are inserted into insertion holes; and reinforced steel wires are provided at the lengthwise edges on the bottom surface inside a housing, thereby reinforcing the bottom of the housing without distortion.

The invention further provides a reinforced leg device configured in such a way that: first bent bars are bent along the shape of the outer surface of the housing from the ends of the insertion bars to the bottom of the housing when the reinforced leg device is folded; support bars are bent parallel to the bottom of the housing at the lower end of the first bent bar when they are folded for storage so that it is bent in the widthwise direction on the outer surface of the housing, and supports the outer bottom of the housing under the reinforced steel wires when being unfolded; and a width connector extends from the supports bars and serves to support the housing. Therefore, it requires only a small storage space and is unfolded for use.

The invention further provides a reinforced leg device configured in such a way that: insertion bars serving as pivots and support bars serving as supports are arranged in vertical locations that differ from each other, when the device is folded for storage or unfolded during use; the insertion bars are supported by reinforced steel wires that are much harder than the housing; and the reinforced steel wires and the bottom of the housing are located between the insertion bars and the support bars when the device is folded for storage or unfolded during use, thereby reinforcing the housing. Therefore, the device can be stored or used without distorting the housing.

### Technical Solution

In accordance with an aspect of the invention, the invention provides a reinforced leg device for a portable charcoal grill, comprising: reinforced steel wires which are provided at the front and rear edges on the bottom surface inside a housing of the portable charcoal grill; two pairs of insertion holes which are formed on the front and rear sidewalls of the housing, above the reinforced steel wires, respectively; and a pair of leg units, both ends of which are inserted into the insertion holes respectively, the leg units being folded to be stored and unfolded to support the portable charcoal grill. Where each of the leg unit comprises: insertion bars which are inserted into the inside of the housing through one pair of insertion holes, respectively; first bent bars which are bent perpendicular to the insertion bars respectively, outside the housing; support bars, bent in the widthwise direction of the charcoal grill from the lower ends of the first bending bars respectively, for supporting the external surface of the housing when the leg unit is unfolded; and a width connector, both ends of which are connected to the other ends of the support bars respectively and the middle of which is bent in the widthwise direction of the charcoal grill to serve as a support leg.

Preferably, the two pairs of insertion holes are each formed on the front and rear sidewalls of the housing so that the lower surface of the insertion bars fitted therethrough contact the upper surface of the reinforced steel wires respectively.

Preferably, the insertion bars are arranged to be perpendicular to the reinforced steel wires. The width connector and the first bent bar are arranged to form an obtuse angle with respect to the axis of the support bar.

Preferably, the reinforced steel wires are each as long as the inner bottom of the housing.

In accordance with another aspect of the invention, the two pairs of insertion holes are each formed on the front and rear sidewalls of the housing so that the lower surface of the insertion bars fitted therethrough contact the upper surface of the reinforced steel wires respectively.

In accordance with another aspect of the invention, the insertion bars are arranged to be perpendicular to the reinforced steel wires. The width connector and the first bent bar are arranged to form an obtuse angle with respect to the axis of the support bar.

### Advantageous Effects

The reinforced leg device according to an embodiment of the invention is configured in such a way that: two pairs of insertion holes are formed on the front and rear sidewalls of the housing of a portable charcoal grill, respectively; and insertion bars integrally formed to both ends of a leg unit are pivotally inserted into each pair of insertion holes. Therefore, the insertion bars can be rotated with respect to the sidewalls of the housing.

The reinforced leg device according to an embodiment of the invention is configured in such a way that: insertion bars of both ends of a leg unit are inserted into insertion holes; and reinforced steel wires are provided at the lengthwise edges on the bottom surface inside the housing. Therefore, the device can reinforce the bottom of the housing without distortion.

The reinforced leg device according to an embodiment of the invention is configured in such a way that: first bent bars are bent along the shape of the outer surface of the housing from the ends of the insertion bars to the bottom of the housing when the reinforced leg device is folded; support bars are bent parallel to the bottom of the housing at the lower end of the first bent bar when they are folded for storage so that it is bent in the widthwise direction on the outer surface of the housing, and supports the outer bottom of the housing under the reinforced steel wires when being unfolded; and a width connector extends from the supports bars and serves to support the housing. Therefore, it requires only a small storage space for storage and is unfolded for use.

The reinforced leg device is configured in such a way that: insertion bars serving as pivots and support bars serving as supports are arranged in vertical locations that differ from each other, when the device is folded for storage or unfolded during use; the insertion bars are supported by reinforced steel wires that are much harder than the housing; and the reinforced steel wires and the bottom of the housing are located between the insertion bars and the support bars when the device is folded for storage or unfolded during use, thereby reinforcing the housing. Therefore, the device can be stored or used without distorting the housing.

### DESCRIPTION OF DRAWINGS

The features and advantages of the invention will be more apparent from the following detailed description in conjunction with the accompanying drawings, in which:

FIG. 1 is a perspective view depicting a general charcoal grill;

FIG. 2 is a cross-sectional view illustrating the charcoal grill, taken along line A-A, in FIG. 2;

FIG. 3 is a cross-sectional view depicting an exemplary example of a conventional charcoal grill;

FIG. 4 is a cross-sectional view depicting another exemplary example of a conventional charcoal grill;

FIG. 5 is a perspective view depicting a conventional support leg device;

FIG. 6 is a side view depicting a reinforced leg device supporting a charcoal grill, according to an embodiment of the invention; and

FIG. 7 is a front view depicting the reinforced leg device supporting a charcoal grill, according to an embodiment of the invention.

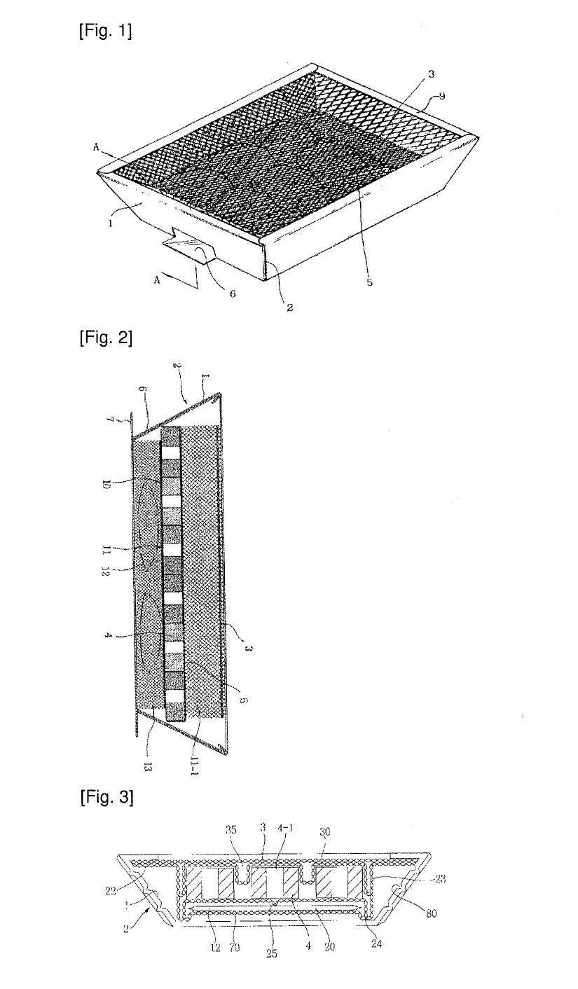

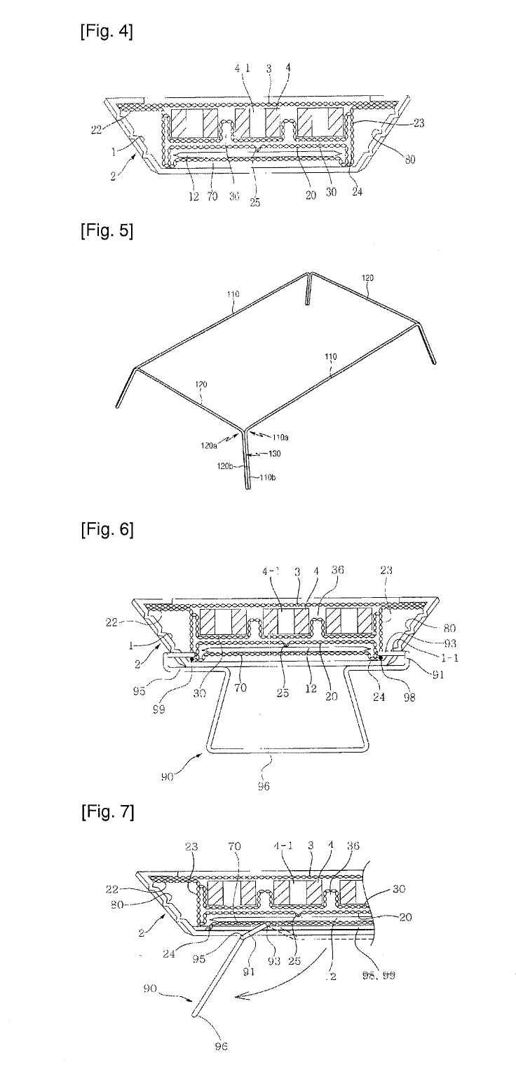

### BRIEF DESCRIPTION OF SYMBOLS IN THE DRAWINGS

1: side wall

1-1: insertion hole

2: housing

3: wire roasting mesh

4: charcoal

4-1: vertical hole

5: charcoal fixing mesh

6: air injection hole

7: door

9: bent band

10: internal support mesh

22: space maintaining part

23: side support part

24: space forming legs

25: pushing portion

30: charcoal fixing mesh

35: interval maintaining downward-protruding part

36: interval maintaining upwardly-protruding part

80: bent groove

90: leg unit

91: first bent bar

93: insertion bar

95: support bar

96: with connectors

98, 99: reinforced steel wires

### BEST MODE

In accordance with a preferred embodiment of the invention, a reinforced leg device for a portable charcoal grill, comprises: reinforced steel wires which are provided at the front and rear edges on the bottom surface inside a housing of the portable charcoal grill; two pairs of insertion holes which are formed on the front and rear sidewalls of the housing, above the reinforced steel wires, respectively; and a pair of leg units, both ends of which are inserted into the insertion holes respectively, the leg units being folded to be stored and unfolded to support the portable charcoal grill.

Where each of the leg unit comprises: insertion bars which are inserted into the inside of the housing through one pair of insertion holes, respectively; first bent bars which are bent perpendicular to the insertion bars respectively, outside the housing; support bars, bent in the widthwise direction of the charcoal grill from the lower ends of the first bending bars respectively, for supporting the external surface of the housing when the leg unit is unfolded; and a width connector, both ends of which are connected to the other ends of the support bars respectively and the middle of which is bent in the widthwise direction of the charcoal grill to serve as a support leg.

The two pairs of insertion holes are each formed on the front and rear sidewalls of the housing so that the lower surface of the insertion bars fitted therethrough contact the upper surface of the reinforced steel wires respectively.

The insertion bars are arranged to be perpendicular to the reinforced steel wires. The width connector and the first bent bar are arranged to form an obtuse angle with respect to the axis of the support bar.

### MODE FOR INVENTION

Hereinafter, exemplary embodiments of the present invention are described in detail with reference to the accompanying drawings.

FIG. 6 is a side view depicting a reinforced leg device for supporting a charcoal grill, according to an embodiment of the invention. FIG. 7 is a front view depicting the reinforced leg device for supporting a charcoal grill, according to an embodiment of the invention.

The reinforced leg device for a portable charcoal grill is configured in such a way that: reinforced steel wires 98 and 99 are provided at the front and rear edges on the bottom surface inside a housing 2 of the portable charcoal grill; two pairs of insertion holes 1-1 are formed on the front and rear sidewalls 1 of the housing 2, above the reinforced steel wires 98 and 99, respectively; and a pair of leg units 90, both ends of which are inserted into the insertion holes 1-1 respectively, are being folded to be stored and unfolded to support the portable charcoal grill.

Each of the leg unit 90 comprises is configured in such a way that: insertion bars 93 are inserted into the inside of the housing 2 through one pair of insertion holes 1-1, respectively; first bent bars 91 are bent perpendicular to the insertion bars 93 respectively, outside the housing 2; support bars 95 are bent in the widthwise direction of the charcoal grill from the lower ends of the first bending bars 91 respectively, and support the external surface of the housing 2 when the leg unit 90 is unfolded; and a width connector 96 connects the both ends to the other ends of the support bars 95 respectively, where the middle portion of the width connector 96 is bent in the widthwise direction of the charcoal grill to serve as a support leg.

The reinforced steel wires 98 and 99 are each as long as the inner bottom of the housing 2.

The two pairs of insertion holes 1-1 are each formed on the front and rear sidewalls 1 of the housing 2 so that the lower surface of the insertion bars 93 fitted therethrough contact the upper surface of the reinforced steel wires 98 and 99 respectively.

The insertion bars 93 are arranged to be perpendicular to the reinforced steel wires 98 and 99. The width connector 96 and the first bent bar 91 are arranged to form an obtuse angle with respect to the axis of the support bar 95.

The reinforced steel wires 98 and 99 are as long as the front and rear edges on the bottom surface inside a housing 2 of the portable charcoal grill and fixed thereto via an adhesive. Two pairs of insertion holes 1-1 are formed on the front and rear sidewalls 1 of the housing 2 so that the lowest point of the holes 1-1 is high enough from the bottom of the housing 2 to meet the highest upper surface of the reinforced steel wires 98 and 99. The insertion bars 93 are inserted into the insertion holes 1-1. The lowest points of the insertion bars 93 contact the highest points of the reinforced steel wires 98 and 99 respectively, so that the reinforced steel wires 98 and 99 support the insertion bars 93. In order to store the reinforced leg device, the leg units 90 can be folded without overlapping each other so that the support bars 95 are folded to the outer bottom surface of the housing 2, as illustrated by hidden line in FIG. 7. Since the reinforced leg device does not increase the height of the housing 2 or require additional storage space during delivery, it can reduce the delivery cost. The insertion bars 93 can serve as hinges by being inserted into the insertion holes 1-1.

In order to use the reinforced leg device, the user grips the width connectors 96 in the folded state, as illustrated in hidden line shown in FIG. 7, and rotates it in the arrow direction with respect to the insertion bars 93, thereby unfolding the leg units 90. When the leg units 90 are unfolded, the support bars 95 hold the unfolded state because they are bent toward the center of the widthwise direction of the housing 2. When the leg units 90 are unfolded, as illustrated in bold line shown in FIG. 7, the insertion bars 93 and the support bars 95 diagonally press the reinforced steel wires 98 and 99 that are much harder than the housing 2 made of aluminum, and the bottom of the housing 2, in their thickness direction. Therefore, the reinforcement of housing 2 is increased by the strength of the reinforced steel wires 98 instead of using only the bottom plate of the housing 2. Therefore, the reinforced leg device according to the invention can support the housing 2 without distortion although an additional frying pan or relatively heavy food is placed on the housing 2. The reinforced leg device according to the invention can easily strengthen the charcoal grill with simple configuration, which does not increase manufacturing costs.

When storing the reinforced leg device, the support bars 95 is rotated with respect to the insertion bars 93 and folded toward the outer surface of the housing 2. In that case, the strength of the reinforced steel wires 98 and 99 and the bottom plate of the housing 2 is not changed. Therefore, they can be delivered without distortion.

### INDUSTRIAL APPLICABILITY

The reinforced leg device for a charcoal grill according to the invention can be applied to a variety of cookers with ease.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A reinforced leg device for a portable charcoal grill, comprising:
reinforced steel wires which are provided at the front and rear edges on the bottom surface inside a housing of the portable charcoal grill;
two pairs of insertion holes which are formed on the front and rear sidewalls of the housing, above the reinforced steel wires, respectively; and
a pair of leg units, both ends of which are inserted into the insertion holes respectively, the leg units being folded to be stored and unfolded to support the portable charcoal grill,
wherein each of the leg unit comprises:
insertion bars which are inserted into the inside of the housing through one pair of insertion holes, respectively;
first bent bars which are bent perpendicular to the insertion bars respectively, outside the housing;
support bars, bent in the widthwise direction of the charcoal grill from the lower ends of the first bending bars respectively, for supporting the external surface of the housing when the leg unit is unfolded; and
a width connector, both ends of which are connected to the other ends of the support bars respectively and the middle of which is bent in the widthwise direction of the charcoal grill to serve as a support leg.

2. The reinforced leg device according to claim 1, wherein the reinforced steel wires are each as long as the inner bottom of the housing.

3. The reinforced leg device according to claim 1, wherein the two pairs of insertion holes are each formed on the front and rear sidewalls of the housing so that the lower surface of the insertion bars fitted therethrough contact the upper surface of the reinforced steel wires respectively.

4. The reinforced leg device according to claim 3, wherein:
the insertion bars are arranged to be perpendicular to the reinforced steel wires; and
the width connector and the first bent bar are arranged to form an obtuse angle with respect to the axis of the support bar.
